(19) United States
(12) Patent Application Publication
(10) Pub. No.: US 2003/0149655 A1
(43) Pub. Date: Aug. 7, 2003

(54) System and method for generating, printing and marketing unique securities

(76) Inventor: Michihiro Sato, Tokyo (JP)

Correspondence Address: Richard C. Woodbridge, Esq., Woodbrige & Associates, P.C., P.O. Box 592, Princeton, NJ, 08542-0592, US

(21) Appl. No.: 10/358,432

(22) Filed: Feb. 4, 2003

(30) Foreign Application Priority Data
Feb. 5, 2002 (JP) 2002-27550

(51) Int. Cl. G06F 17/60

(52) U.S. Cl. 705/37; 705/40

(57) ABSTRACT

Certificates of Security are issued for acquiring funds by a business operator in exchange for said certificates of securities, on which are printed by a printer: a dividend wording or legend indicating that said business operator will distribute profits obtained as a result of business activities to persons who own said certificates of securities; a interest wording or legend indicating that said business operator will pay interest periodically to said persons who own said certificates of securities; and a warranty wording or legend indicating that national and/or local government(s), or other public institutions warrant the repayment of the originally acquired funds within predetermined limits in case said business operator becomes unable to pay the interests according to the interest payment wording due to reasons such as a business failure.

The invention can be used by business operators to acquire funds easily. The security issued is a new type of financial product for investors, and which is neither stock nor bond certificates. A computer system is employed to generate and print said securities and to assist in the marketing of said securities.

### CROSS REFERENCE TO RELATED APPLICATIONS

The entire disclosure of Japanese Patent Application 2002-27550 filed on Feb. 5, 2002, including the specification, claims, drawings and summary, are hereby incorporated by reference in its entirety and priority is claimed from said application.

### BACKGROUND OF THE INVENTION

1. Field of the Invention

A system and method are described for generating, printing and marketing a unique security that includes selected features of common stock and bonds.

2. Description of Related Art

Stock certificates are a well-known type of certificate of securities that represent the positions or rights of stockowners. A business operator issues stock certificates that represent the positions or rights of investors in return for acquiring funds from the investors. Those who purchased stock certificates (i.e., stockholders) are allowed to participate in the operation of the company that issued the stock certificates based on the positions and rights given to them in return. In other words, stockholders can attend stockholders meetings, participate in voting, and demand dividends from the company that issued stock certificates.

Moreover, stockholders are allowed to sell the stock certificates to third parties. By selling the stocks at prices exceeding the original purchase prices, they can earn profits that are equal to the differences between them.

Bonds are another type of well-known securities that are issued by national or local governments, entities established based on special laws, or private enterprises for obligations they have to the public as a whole. Bonds are characterized in that they have predetermined redemption dates, after which the bond issuers are to pay to the bond owners corresponding principals and interests. Bond owners are also allowed to sell bonds at prices exceeding the original purchase prices and earn profits that are equal to the differences between them.

However, a business operator sometimes may not be able to acquire sufficient funds only by stock issues. Moreover, by issuing bonds, a business operator becomes obligated to pay the principals and interests after the redemption dates, so that bond issuing results in a high burden for a business owner.

On the other hand, if a new type of financial product, which is different from stocks and bonds, is invented, it means a new opportunity to earn profits for an investor who normally buys stocks and bonds.

### SUMMARY OF THE INVENTION

Consequently, it is an intention of the present invention to provide a new type of financial product, securities that are neither stock certificates nor bond certificates, on which wordings for dividends, interests and warranties are provided, but no redemption dates are shown, computers for displaying contents printed on said securities on screens or printing, printers for printing said securities, and a method of forming a market for trading said securities.

Said task can be solved by the invention described in the claims. The invention relates to securities issued for acquiring funds by a business operator in exchange for said certificates of securities, on which are printed:

a. a dividend wording or legend describing that said business operator will distribute profits obtained as a result of business activities to persons who own said certificates of securities;

b. an interest wording or legend describing that said business operator will pay interest periodically to said persons who own said certificates of securities; and,

c. a warranty wording or legend describing that national and/or local government(s), or other public institutions warrant the repayment of the originally acquired funds within predetermined limits in case said business operator becomes unable to pay the interests according to the interest payment wording due to reasons such as a business failure, but no redemption date is indicated. The certificate of securities described does not burden the business operator with the liability of repaying the principal amounts, as they do not include any concept of redemption.

According to the issued certificates of securities, the owners of the certificates of securities may receive dividends. The owners of the certificates of securities may also receive interest periodically. Moreover, national and/or local government(s), or other public institutions warrant to the owners of the certificates of securities the repayment of the originally acquired funds within a predetermined limit in case said business operator becomes unable to pay the interests according to the interest payment wording due to reasons such as a business failure. Thus, the issued securities should be an attractive financial product for investors.

Said dividend wording, said interest wording, and said warranty wording are printed by printers on the issued certificates of securities. Therefore, a large quantity of the certificates of securities described can be produced inexpensively.

The computer system, according to the present invention, comprises: an input unit for receiving said dividend wording, said interest wording, and said warranty wording; and a printing order transmission means for transmitting printing orders for printing on paper certificates said dividend wording, said interest wording, and said warranty wording entered through said input unit. The certificates of securities can be produced in large quantities inexpensively using the computer described above.

The printer, according to the present invention, prints said dividend wording, said interest wording, and said warranty wording, respectively, on the certificates of securities upon receiving printing orders transmitted by the computer system. The certificates of securities can be produced in large quantities inexpensively using the printer described above.

The overall computer system, according to the present invention, comprises: an input unit that receives said dividend wording, said interest wording, and said warranty wording; a recording means for recording said dividend wording, said interest wording, and said warranty wording entered through said input unit; and a display means for displaying said dividend wording, said interest wording, and said warranty wording recorded by said recording means.

The computer system makes it possible to confirm information concerning said certificates of securities without having to print on paper. Therefore, it is possible to advertise or market the certificates of securities via a network by means of the computer system instead of printing the certificates of securities and issuing said certificates of securities in order to fund providers to acquire funds. In fact, it may be possible to purchase said securities before they are technically printed and issued.

The market forming method described comprises encouraging those who have never purchased any securities to purchase securities described and trade said securities as needed. The market forming method promotes the securities described to be traded in the market. Said type of securities is a financial product which has never existed in the market. Therefore, the market forming method described makes it possible to create a new financial market.

### BRIEF DESCRIPTION OF THE DRAWINGS

FIG. 1 illustrates a possible Certificate of Security issued according to the preferred embodiment of the system and method of the present invention.

FIG. 2 is a block diagram of the overall structure of an embodiment of the present invention.

FIG. 3 is a block diagram showing greater detail of the computers depicted in FIG. 2.

FIG. 4 is a flowchart representing a segment of a program executed by the securities company's computer according to the embodiment depicted in FIG. 3.

FIG. 5 is a flowchart representing a segment of a program executed by the investor's computer according to the embodiment depicted in FIG. 3.

FIG. 6 is a block diagram of the overall structure of an alternative embodiment of the present invention.

FIG. 7 is a block diagram showing greater detail of the printer depicted in FIG. 6.

FIG. 8 is a flowchart representing a segment of a program executed by the securities company's computer according to the embodiment depicted in FIG. 6.

FIG. 9 is a flowchart representing a segment of a program executed by the investor's computer according to the embodiment depicted in FIG. 6.

### DESCRIPTION OF THE PREFERRED EMBODIMENTS

Preferred embodiments of the securities, computers for displaying contents printed on said securities on screens or printing, printers for printing said securities, and a method of forming a market for trading said securities according to the present invention will be described below referring to the accompanying drawings.

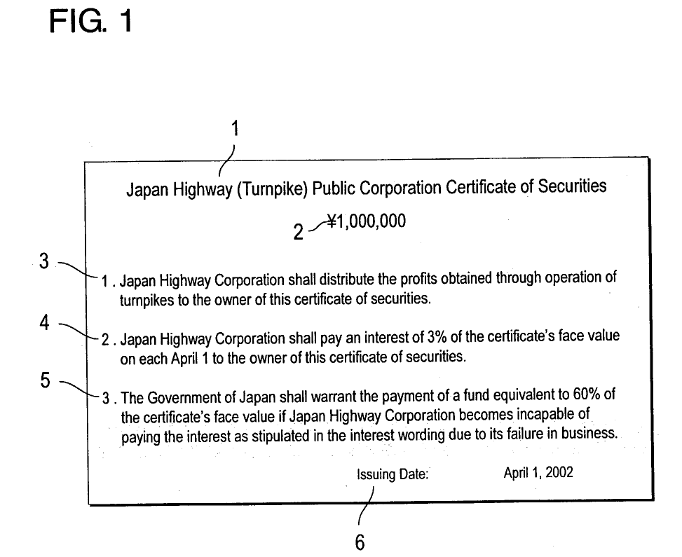

FIG. 1 is a view of a certificate of securities according to the preferred embodiment of the present invention. Written on this certificate of securities according to this embodiment are: a wording or legend 1 of “Japan Highway (Turnpike) Public Corporation Certificate of Securities,” a wording or legend 2 of “¥1,000,000,” a wording or legend 3 of “Japan Highway Corporation shall distribute the profits obtained through operation of turnpikes to the owner of this certificate of securities,” a wording or legend 4 of “Japan Highway Corporation shall pay an interest of 3% of the certificate's face value on each April 1 to the owner of this certificate of securities,” a wording or legend 5 of “The Government of Japan shall warrant the payment of a fund equivalent to 60% of the certificate's face value if Japan Highway Corporation becomes incapable of paying the interest as stipulated in the interest wording due to its failure in business,” and a wording 6 of “Issuing Date: Apr. 1, 2002.”

The wording 1 of “Japan Highway (Turnpike) Public Corporation Certificate of Securities” indicates that the present certificate of securities concerns the turnpikes operated by Japan Highway Public Corporation. From this wording 1, the person who is buying this certificate of securities can confirm that it is issued by Japan Highway Public Corporation in order to acquire a fund.

The wording 2 of “¥1,000,000” indicates the amount of fund being acquired by the issue of this certificate. The wording 3 of “Japan Highway Corporation shall distribute the profits obtained through operation of turnpikes to the owner of this certificate of securities” indicates that the owner of the certificate shall be paid dividends by Japan Highway Corporation.

The wording 4 of “Japan Highway Corporation shall pay an interest of 3% of the certificate's face value on each April 1 to the owner of the certificate” indicates that the owner of the certificate shall be paid interest by Japan Highway Corporation. In other words, the owner of the particular certificate shall receive ¥30,000 every year from Japan Highway Corporation.

The wording 5 of “The Government of Japan shall warrant the payment of a fund equivalent to 60% of the certificate's face value if Japan Highway Corporation becomes incapable of paying the interest as stipulated in the interest wording due to its failure in business” indicates that the Government of Japan shall warrant the repayment of the face value of the certificate up to a specified limit.

Consequently, the owner of the certificate will be guaranteed to receive 60% of the face value of the certificate from the Government of Japan even when Japan Highway Corporation becomes unable to pay interests due to business failures. As such, this certificate of securities will increase the credibility of the securities in the minds of the buyers, thus being able to enhance the buyer's purchase desire.

Moreover, the government's warrant is limited to a certain level. Therefore, this certificate of securities will not burden the government with the full amount repayment liability.

The wording 6 of “Issuing Date: Apr. 1, 2002” is intended to clarify the issuing date.

The certificate of securities described in the above is the certificate of securities according to an embodiment of the present invention. The securities according to the present invention are not limited in any way by the abovementioned certificate of securities. For example, the wording 1 can be anything as long as the certificate of securities according to the invention relates to acquisition of a business operator such as “X Department Store (Shinjuku Branch) Certificate of Securities,” “P Airport Certificate of Securities,” and “W Public Housing Certificate of Securities.”

Moreover, the degree of warranty of repayment liabilities by the national government indicated in the wording 5 is not limited to “60%” but rather can be any degree or ratio warranted by the a national and/or local government(s), for example, 10, 20 or 50%. Further, the entity that warrants the repayment liabilities in the wording 5 does not have to be “Japan,” but rather can be any arbitrary country in the world such as U.S., China, Korea, and U.K.

Furthermore, the warranting government in the wording 5 can be an arbitrary local government(s) in the world such as Tokyo, Osaka, Los Angeles, and Beijing. The buyer of the securities according to the invention is not limited to a Japanese citizen. A citizen of an arbitrary country of the world, such as a U.S., Chinese, Korean and U.K. citizen can be a buyer of the bond according to the invention.

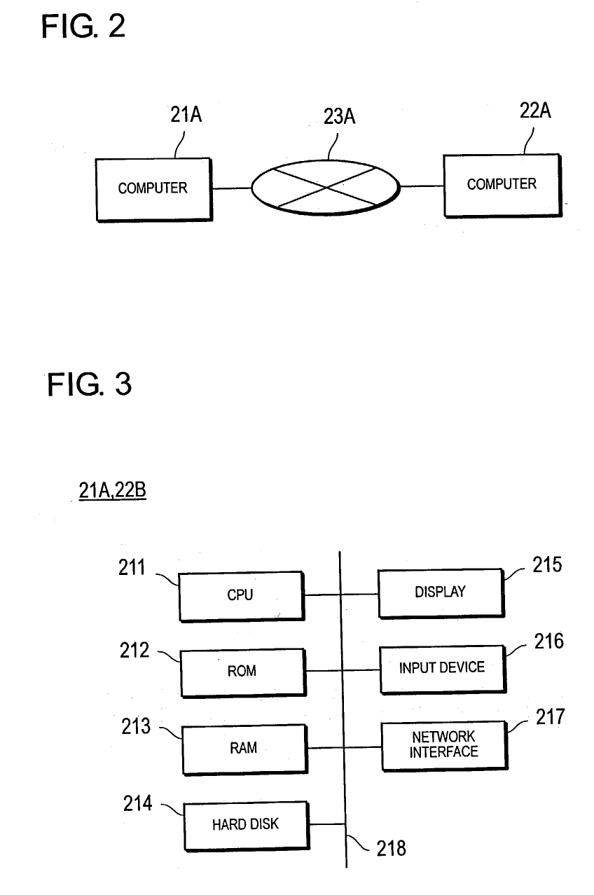

FIG. 2 is a block diagram showing the entire structure of the securities information offering system according to the second embodiment of the present invention. The securities information offering system according to this embodiment comprises a computer 21A installed at a securities company and a computer 22A owned by an investor, which are interconnected communicably via a network 23A. The number and type of the devices connected to the network 23A are not limited by the example shown in FIG. 2.

FIG. 3 is a block diagram showing the constitution of the computers 21A and 22A according to this embodiment. With reference to FIG. 3, the computers 21A and 22A each has a CPU 211 for conducting various control and arithmetic processes, a ROM 212 for storing various programs and data, a RAM 213 for temporarily storing data as a working area, a hard disk 214 for storing various programs and data, a display 215 for conducting various displays, an input device 216 such as a keyboard and a mouse for conducting various inputs, a network interface 217 for communicating with other devices on the network, and others, all of which area interconnected via a bus 218 for exchanging signals.

The network 23A can be a public network such as a telephone network, a mobile communication network, an ISDN and a packet exchange network, or a computer network such as a LAN, a WAN and the Internet.

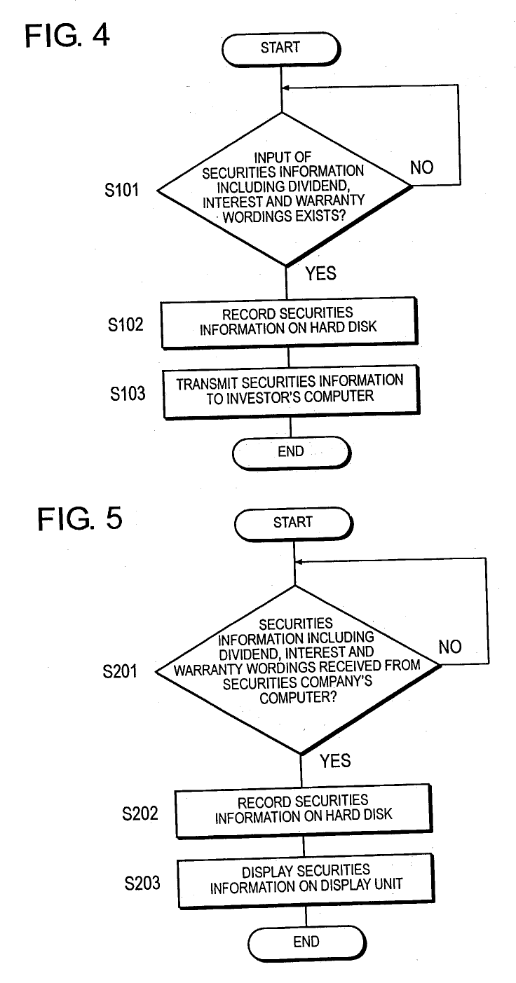

Next, the outline of the operation of the securities information offering system according to this embodiment will be described. FIG. 4 and FIG. 5 are the flowcharts of the procedures of the securities information offering processes of the computers 21A and 22A. The algorithms shown as the flowcharts of FIG. 4 and FIG. 5 are stored as the control programs in either the ROM 212 or the hard disk 214 of the computers 21A and 22A respectively, and are executed by the CPU 211.

In FIG. 4, the computer 21A installed in the securities company waits for securities information including the dividend wording 3, the interest wording 4, and the warranty wording 5 to be entered (S101: No). The operator at the securities company enters into the computer 21A via the input device 216 the dividend wording 3, the interest wording 4, and the warranty wording 5 for a specific securities similar to the one shown in the first embodiment, as well as other securities information, e.g., a wording 1 concerning the title, and a wording 2 concerning the face value and other information relaying to said securities certificate.

When the computer 21A receives the securities information including the dividend wording 3, the interest wording 4, and the warranty wording 5 (S101: Yes), it records the entered securities information into the hard disk 214 (S102), and transmits said securities information to the computer owned by the investor 22A via the network interface 217 and the network 23A (S103). The procedure of the transmission of the securities information in the step S103 can be automatically done according to the securities information input procedure in the step S101, or can be performed upon receiving the transmission request from the computer 22A owned by the investor.

In FIG. 5, upon receiving the securities information including the dividend wording 3, the interest wording 4, and the warranty wording 5 from the computer 21A owned by the investor via the network 23A and the network interface 217 (S201), the computer 22A stores the received information into the hard disk 214 (S202), and displays the same on the display unit 215 (S203).

In this embodiment, the investor can confirm the contents of the securities according to the present information from his/her office or home and instantaneously purchase any desired securities through on-line procedures using the computer 22A. Moreover, the securities company can advertise and sell simultaneously the securities according to the invention through the network alone.

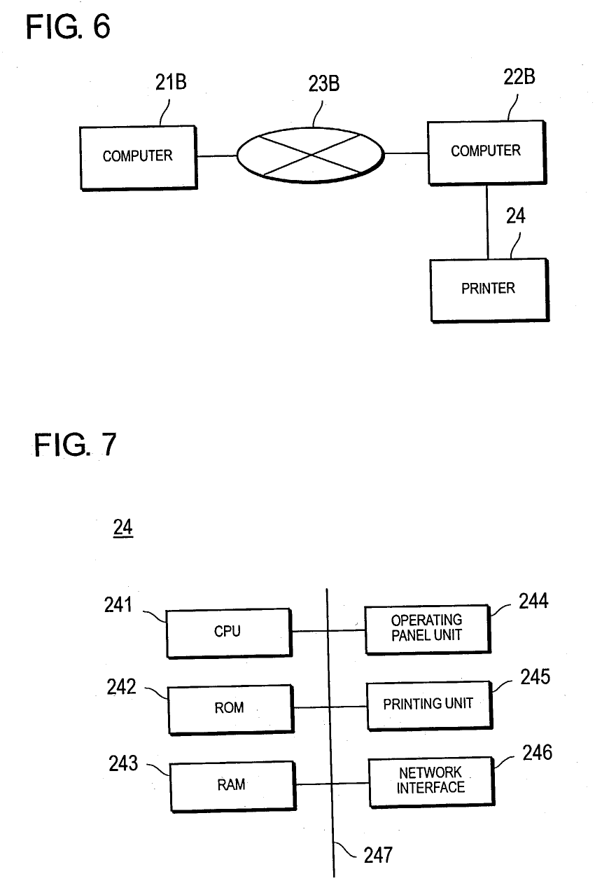

FIG. 6 is a block diagram showing the entire structure of the securities information offering system according to the third embodiment of the present invention. The securities information offering system according to this embodiment comprises, similar to the case of the securities information offering system according to the aforementioned second embodiment, a computer 21B installed at a securities company and a computer 22B owned by an investor, which are interconnected communicably via a network 23B, while a printer 24 is connected to the computer 22B.

The computers 21B and 22B of this embodiment have constitutions similar to those of the computers 21A and 22A of the second embodiment.

FIG. 7 is a block diagram showing the constitution of the printer 24 according to this embodiment. With reference to FIG. 7, the printer 24 has, in addition to a CPU 241, a ROM 242, a RAM 243, a network interface 246, and a bus 247, an operating panel 244 consisting of a touch panel for various inputs and displays, fixed keys, display lamps, etc., and a printing unit 245 for printing image data.

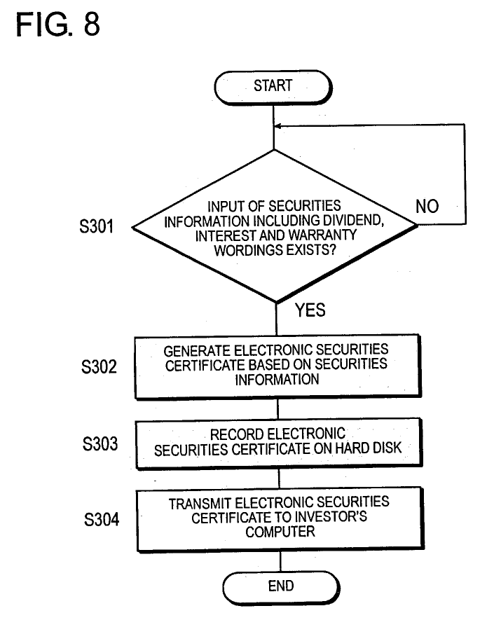

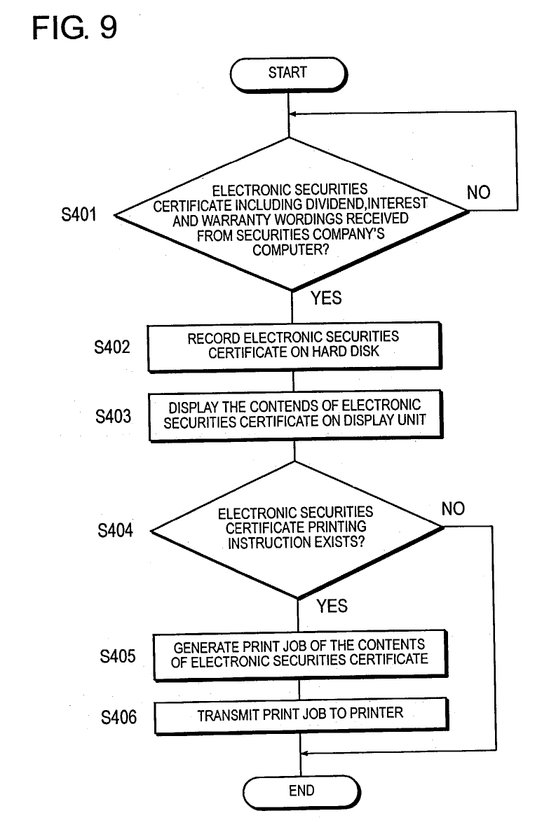

FIG. 8 and FIG. 9 are the flowcharts showing the procedures of the securities issuing processes in the computers 21B and 22B in this embodiment. The algorithms shown as the flowcharts of FIG. 8 and FIG. 9 are stored as the control programs in either the ROM 212 or the hard disk 214 of the computers 21B and 22B respectively, and are executed by the CPU 211.

In FIG. 8, the computer 21B installed in the securities company waits for securities information including the dividend wording 3, the interest wording 4, and the warranty wording 5 to be entered (S301: No). The operator at the securities company enters into the computer 21B via the input device 216 the dividend wording 3, the interest wording 4, and the warranty wording 5 for a specific securities as well as other securities information as indicated in the aforementioned first embodiment.

When the computer 21B receives the securities information including the dividend wording 3, the interest wording 4, and the warranty wording 5 (S301: Yes), it generates an electronic securities certificate based on the received securities information (S302). The electronic securities certificate mentioned here is a version based on electronic data of the securities certificate shown in the first embodiment (FIG. 1), and contains the wording 1 for the title of the securities, the wording 2 for the face value, the dividend wording 3, the interest wording 4, and the warranty wording 5 for the specific securities as well as the electronic signature of the securities issuer (business operator) for guarantying the legitimacy of the securities certificate. Moreover, such an electronic securities certificate is provided with a specified copy protection for the purpose of preventing illegal modification or copying. The computer 21B records the generated electronic securities certificate in the hard disk 214 (S303), and transmits simultaneously said electronic securities certificate to the computer 22B owned by the investor via the network interface 217 and the network 23B (S304). The procedure of the transmission of the securities information in the step S304 can be automatically done according to the securities information input procedure in the step S302, or can be performed upon receiving the transmission request from the computer 22B owned by the investor.

In FIG. 9, upon receiving the electronic securities certificate including the dividend wording 3, the interest wording 4, and the warranty wording 5 from the computer 21B owned by the investor via the network 23B and the network interface 217 (S401), the computer 22B stores the received electronic securities certificate into the hard disk 214 (S402), and displays its contents on the display unit 215 (S403).

In this embodiment, the electronic securities certificate can be circulated through the network as the original of the securities certificate, so that the investor can purchase the contents of the securities according to the present information from his/her office or home and instantaneously obtain the certificate of any desired securities through on-line procedures using the computer 22B. Moreover, the securities company can sell the securities according to the invention through the network alone and is freed from the burden of mailing the securities certificate later.

Further, the computer 22B can be a type which prints out the contents of the electronic securities certificate by means of the printer 24, in addition to or instead of displaying them on its display unit. In other words, it is possible to provide the electronic securities with a protection electronically so that it can be printed only once, so that the only one copy of said securities certificate can be printed and circulated through the market as its original. In this case, with reference to FIG. 9, the computer 22B waits for the printing instruction of the electronic securities certificate (S404), generates a print job of the contents of the electronic securities certificate recorded on the hard disk 214 (S405), and transmits said print job to the printer 24 (S406). The printing output protection applied on the electronic securities certificate as mentioned above does not have to be a type that limits the printing to only once, but can be a multiple print type or a no-limit type (i.e., no protection).

What is claimed is:

1. A computer system for acquiring funds for a business operator in exchange for certificates of securities which include: a dividend legend indicating that said business operator will distribute profits obtained as a result of business activities to persons who own said certificates of securities; an interest legend indicating that said business operator will pay interest periodically to individuals who own said certificates of securities; and a warranty legend indicating that national and/or local government(s), or other public institutions, warrant the repayment of the originally acquired funds within predetermined limits in case said business operator becomes unable to pay the interest according to the interest payment legend due to reasons such as business failure, said system comprising:
an input unit for receiving said dividend legend, said interest legend, and said warranty legend;
a printing order transmission means for transmitting printing orders for printing on paper that dividend legend, said interest legend; and said warranty legend entered through said input unit; and,
a printer that prints said divided legend, said interest legend, and said warranty legend, respectively, on certificates of securities upon receiving printing orders transmitted by said printing order transmission means.

2. A computer system for acquiring funds for a business operator in exchange for certificates of securities which include: a dividend legend indicating that said business operator will distribute profits obtained as a result of business activities to persons who own said certificates of securities; an interest legend indicating that said business operator will pay interest periodically to individuals who own said certificates of securities; and a warranty legend indicating that national and/or local government(s), or other public institutions warrant the repayment of the originally acquired funds within predetermined limits in case said business operator becomes unable to pay the interest according to the interest payment legend due to reasons such as business failure, said system comprising:
an input unit that receives said dividend legend, said interest legend, and said warranty legend;
a recording means for recording said dividend legend, said interest legend, and said warranty legend entered through said input unit; and,
a display means for displaying said divided legend, said interest legend, and said warranty legend recorded by said recording means.

3. A method for generating certificates of securities issued for acquiring funds by a business operator in exchange for said certificates of securities, said method comprising the steps of:
a. inputting a divided legend indicating that said business operator will distribute profits obtained as a result of business activities to persons who own said certificates of securities;
b. inputting an interest legend indicating that said business operator will pay interest periodically to individuals who own said certificates of securities;
c. inputting a warranty legend indicating that national and/or local government(s), or other public institutions warrant the repayment of the originally acquired funds within predetermined limits in case the business operator becomes unable to pay the interest according to the interest payment legend due to reasons such as business failure;
d. outputting the input from steps a, b, and c above to either a printer or a display means.

4. The method of claim 3 wherein said outputting step d comprises:
e. transmitting said inputs from steps a, b and c to a printing order transmission means for transmitting printing orders for printing on paper said dividend legend, said interest legend, and said warranty legend entered in steps a, b, and c; and
f. printing said certificates on a printer, said certificates including said dividend legend, said interest legend, and said warranty legend upon receiving printing orders transmitted in step e above.

5. The method of claim 3 wherein said output step d comprises:
e. recording on a recording means said dividend legend, said interest legend, and said warranty legend, and
f. displaying on a display means said dividend legend, said interest legend and said warranty legend recorded by said recording means.

6. The method of claim 5, further comprising:
g. electronically marketing said securities displayed in step f above.

7. Printed or electronic Certificates of Securities issued for acquiring funds by a business operator in exchange for said certificates of securities, said securities comprising:
a dividend legend indicating that said business operator will distribute profits obtained as a result of business activities to persons who own said certificates of securities;
an interest legend indicating that said business operator will pay interest periodically to individuals who own said certificates of securities; and,
a warranty legend indicating that national and/or local government(s), whether public institutions warrant the repayment of the originally acquired funds within predetermined limits in case said business operator becomes unable to pay the interest according to the interest payment legend due to reasons such as a business failure,
wherein said securities are distributed electronically or by printing to potential investors.
